(19) United States
(12) Patent Application Publication
(10) Pub. No.: US 2026/0100536 A1
(43) Pub. Date: Apr. 9, 2026

(54) CONNECTOR AND ROUTING UNIT

(71) Applicant: Yazaki Corporation, Tokyo (JP)

(72) Inventors: Ayumu Ishikawa, Fujieda-shi (JP); Yuki Hiruta, Fujieda-shi (JP); Hideto Kumakura, Makinohara-shi (JP)

(21) Appl. No.: 19/348,463

(22) Filed: Oct. 2, 2025

(30) Foreign Application Priority Data
Oct. 8, 2024 (JP) 2024-176240

(51) Int. Cl. H01R 13/58; H01R 13/502

(52) U.S. Cl. CPC H01R 13/582; H01R 13/502

(57) ABSTRACT

A connector includes: a housing having a cylindrical portion and a plurality of terminal portions arranged in a first cross direction. Each of the terminal portions includes a leading end portion positioned on the first end side of the cylindrical portion and a base end portion positioned on a second end side in an axial direction of the cylindrical portion. The housing includes an insulating wall extending in the axial direction. The insulating wall positioned on the second end side of the cylindrical portion has an end including a first end region positioned on one side in a second cross direction crossing the axial direction and the first cross direction, and a second end region positioned adjacent to the first end region on another side in the second cross direction and positioned nearer to the first end of the cylindrical portion than the first end region.

### BACKGROUND OF THE INVENTION

### Field of the Invention

An embodiment of the present invention relates to a connector and a routing unit.

Priority is claimed on Japanese Patent Application No. 2024-176240 filed in Japan on Oct. 8, 2024, the content of which is incorporated herein by reference.

### Description of Related Art

A connector including a housing and a plurality of terminal-equipped electric wires is known. The terminal-equipped electric wires each include a terminal portion for connecting that electric wire to a mating connector and an electric wire extending from the terminal portion. The housing has a fitting cylindrical portion (outer housing) in which the terminal portions of the plurality of terminal-equipped electric wires are disposed. The fitting cylindrical portion has a role of fitting to the mating connector. The plurality of electric wires each extending from the terminal portion are bent in an orthogonal direction orthogonal to a direction of insertion of the terminal portion, with respect to the fitting cylindrical portion and are then drawn out to the outside of the housing.

### REFERENCE

### Patent Literature

Patent Literature 1: Japanese Unexamined Patent Application, First Publication No. 2011-222345

### SUMMARY OF THE INVENTION

### Problems to be Solved by the Invention

Meanwhile, one of this type of connectors includes an electrically insulating wall (hereinafter, referred to simply as insulating wall) disposed between adjacent terminal portions inside the fitting cylindrical portion. The insulating wall has a role of preventing electrical short circuit between the adjacent terminal portions.

In this type of connector, the plurality of electric wires extending in the orthogonal direction from the plurality of terminal portions disposed inside the fitting cylindrical portion may extend in a tilted terminal portion arrangement direction with respect to the orthogonal direction.

However, when the foregoing insulating walls are disposed and the electric wires extend in a tilted direction from the terminal portions as described above, some tilted ones of the electric wires may each interfere with the insulating wall adjacent to that electric wire.

An embodiment provides a connector and a routing unit capable of suppressing interference of an electric wire extending from a terminal portion with an insulating wall of a housing.

### Means for Solving the Problem

A connector according to one embodiment includes: a housing having a cylindrical portion having a portion on a first end side in an axial direction, which is a fitting portion to be fitted to a mating connector; a plurality of terminal portions arranged in a first cross direction crossing in the axial direction of the cylindrical portion inside the cylindrical portion, where each of the terminal portions includes a leading end portion positioned on the first end side of the cylindrical portion and to be connected to the mating connector and a base end portion positioned on a second end side in the axial direction of the cylindrical portion and to be connected to an electric wire. The housing includes an insulating wall extending in the axial direction of the cylindrical portion between the terminal portions adjacent to each other in the first cross direction, where the first cross direction is a thickness direction. The insulating wall has an end positioned on the second end side of the cylindrical portion, where the end includes a first end region positioned on one side in a second cross direction crossing the axial direction and the first cross direction, and a second end region positioned adjacent to the first end region on another side in the second cross direction and positioned nearer to the first end of the cylindrical portion than the first end region.

A routing unit according to one embodiment includes a connector and a plurality of electric wires respectively connected to the base end portions of the plurality of terminal portions.

### Effects of the Invention

The connector and the routing unit of one embodiment of the present invention enable suppression of interference of the electric wire connected to the terminal portion with the insulating wall of the housing.

### BRIEF DESCRIPTION OF THE DRAWINGS

FIG. 1 is a perspective view, as viewed from a front side, of a routing unit according to an embodiment;

FIG. 2 is a perspective view, as viewed from a rear side, of the routing unit according to the embodiment;

FIG. 3 is a rear view, as viewed from the rear side, of the routing unit according to the embodiment;

FIG. 4 is an exploded perspective view in a situation where a terminal portion and an electric wire are removed from an outer housing in the routing unit of the embodiment;

FIG. 5 is an exploded perspective view of the terminal portion illustrated in FIG. 4;

FIG. 6 is a perspective view, as viewed from the rear side, of the outer housing provided in the routing unit of the embodiment;

FIG. 7 is a rear view, as viewed from the rear side, of the outer housing provided in the routing unit according to the embodiment; and

FIG. 8 is a cross-sectional view taken along line VIII-VIII in FIG. 7.

### DETAILED DESCRIPTION OF THE INVENTION

An embodiment will hereinafter be described with reference to the drawings. In the following description, components having the same or similar functions are denoted by the same reference numbers. Redundant descriptions of these components may be omitted.

In the present disclosure, the terms are defined as follows. The term “connection” is not limited to a mechanical connection but may include an electrical connection. In addition, the term “connection” is not limited to a direct connection between two elements that are to be connected to each other but may include a connection between two elements that are to be connected to each other with another element interposed therebetween.

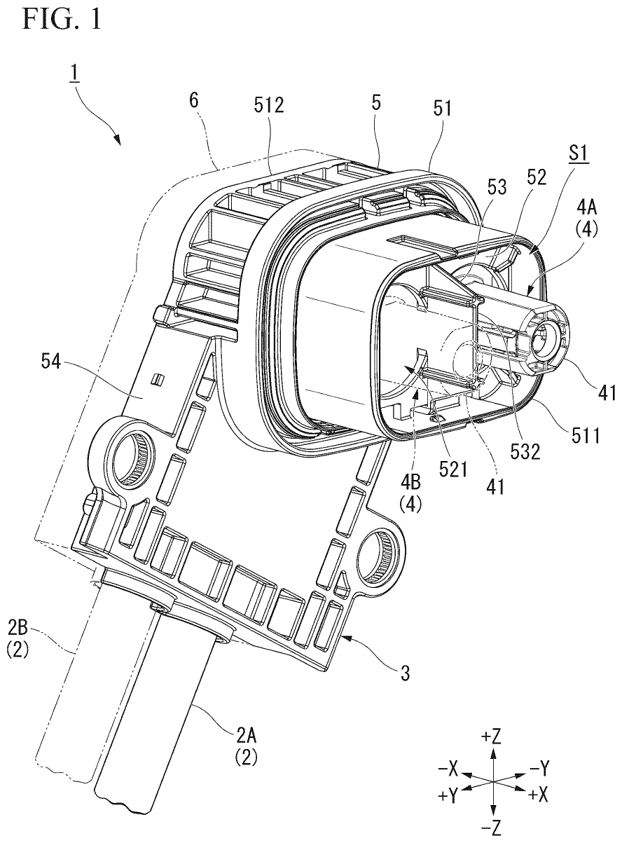

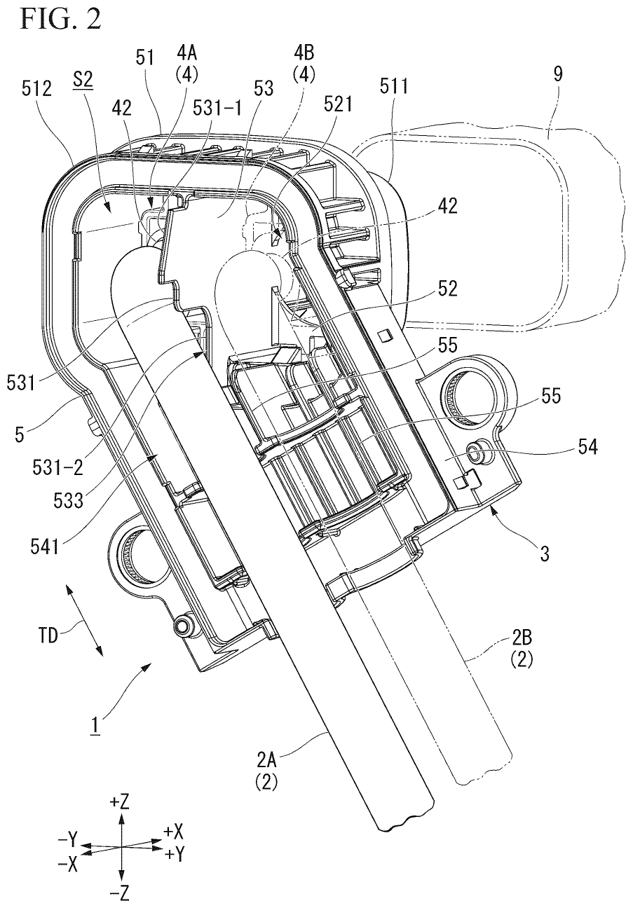

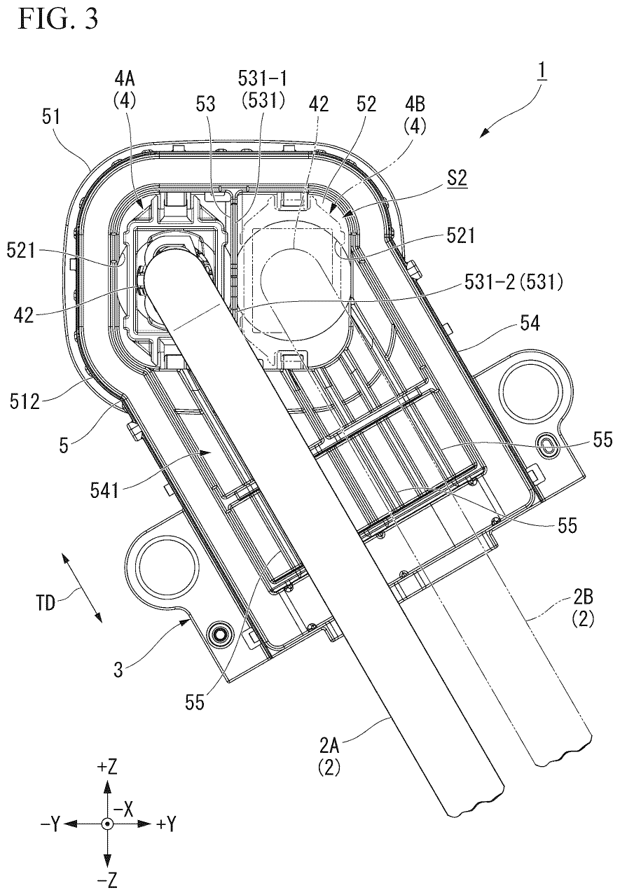

In the present disclosure, a +X direction, a −X direction, a +Y direction, a −Y direction, a +Z direction, and a −Z direction are defined as follows. The +X direction is a direction from a connector 3 toward a mating connector 9 (see FIG. 2). The −X direction is a direction opposite to the +X direction. When the +X direction and the −X direction are not distinguished from each other, they are simply referred to as “X direction”. The Y direction is a direction crossing (for example, orthogonal to) the X direction. The +Y direction is a direction from a first terminal portion 4A to a second terminal portion 4B described later (see FIGS. 1 to 3). The −Y direction is a direction opposite to the +Y direction. When the +Y direction and the −Y direction are not distinguished from each other, they are simply referred to as “Y direction”. The +Z direction is a direction crossing (for example, orthogonal to) the X and Y directions. The +Z direction is a direction from a guide portion 54 toward a cylindrical portion 51 of an outer housing 5 (housing) described later (see FIG. 3). The −Z direction is a direction opposite to the +Z direction. When the +Z direction and the −Z direction are not distinguished from each other, they are simply referred to as “Z direction”. The X direction corresponds to an axial direction of the cylindrical portion 51 of the outer housing 5 described later. The Y direction is an example of “first cross direction”. The Z direction is an example of “second cross direction”. For convenience of description, the +X direction side may hereinafter be referred to as a “front side” or “forward”, and the −X direction side may hereinafter be referred to as a “rear side” or “rearward”.

### 1. Configuration of Routing Unit

As illustrated in FIGS. 1 to 3, a routing unit 1 of one embodiment includes a plurality of electric wires 2 and a connector 3. The connector 3 is a component for electrically connecting the plurality of electric wires 2 to the mating connector 9 (see FIG. 2). The connector 3 is, for example, a connector for use in a vehicle such as an electric vehicle (EV), a hybrid electric vehicle (HEV), or a plug-in hybrid electric vehicle (PHEV). The connector 3 is, for example, a high-voltage connector through which a current having a voltage of 100 volts (V) or more flows. The connector 3 of the present embodiment is a connector that supports two electrodes. However, the connector 3 may be a connector that supports three or more electrodes.

### 2. Configuration of Connector

As illustrated in FIG. 1, the connector 3 includes a plurality of terminal portions 4, the outer housing 5 (housing), and a rear cover 6.

### 3. Configuration of Terminal Portion

As illustrated in FIGS. 1 to 3, the plurality of terminal portions 4 is arranged in the Y direction inside the cylindrical portion 51 of the outer housing 5 described later. In FIGS. 1 to 3, the number of terminal portions 4 is two. The first terminal portion 4A and the second terminal portion 4B, which are the two terminal portions 4, are arranged in order in the +Y direction. FIGS. 1 to 4 illustrate the routing unit 1 in such a manner that the first terminal portion 4A is clearly illustrated, and that the second terminal portion 4B is illustrated using an imaginary line or the second terminal portion 4B is omitted.

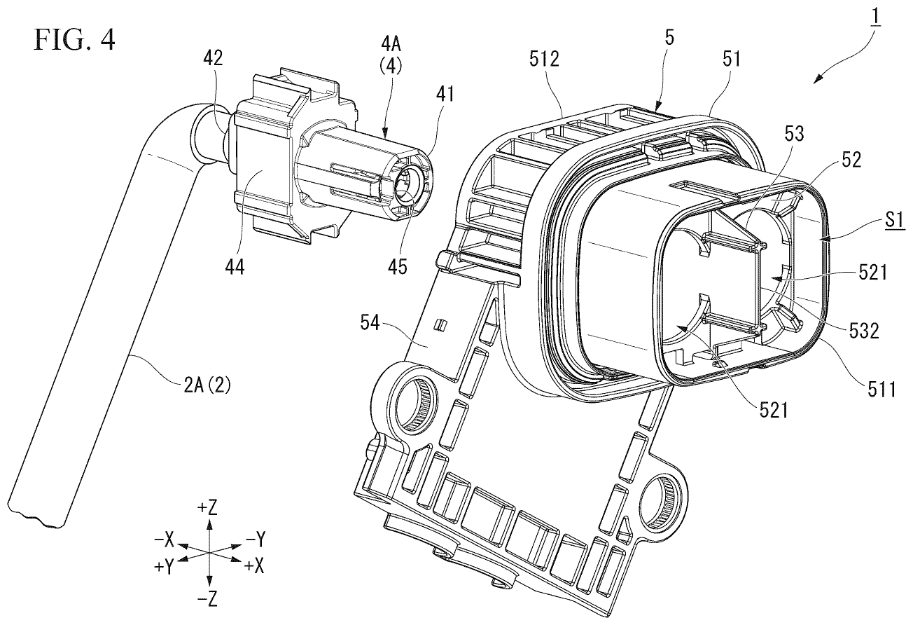

As illustrated in FIG. 4, each of the terminal portions 4 includes a leading end portion 41 positioned on the +X direction side and a base end portion 42 positioned on the −X direction side. The leading end portion 41 of each of the terminal portions 4 is a portion to be connected to the mating connector 9 (see FIG. 2). The electric wire 2 is connected to the base end portion 42 of each of the terminal portions 4 (hereinafter referred to simply as “the terminal portion 4” as appropriate). In the present embodiment, the electric wire 2 connected to the first terminal portion 4A is referred to as a “first electric wire 2A”, and the electric wire 2 connected to the second terminal portion 4B is referred to as a “second electric wire 2B”.

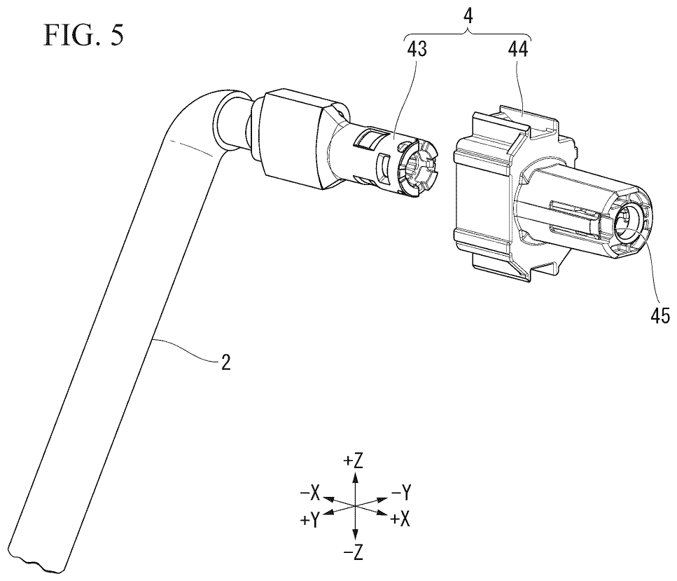

As illustrated in FIG. 5, the terminal portion 4 of the present embodiment includes a terminal 43 and an inner housing 44. The terminal 43 is made of a material having electrical conductivity and is fixed to an end portion of the electric wire 2. The inner housing 44 is made of a material having an electrical insulation property (e.g., a synthetic resin material) and covers the terminal 43. The inner housing 44 has an exposure hole 45, which allows the terminal 43 to be exposed in the forward direction (i.e., in the +X direction). The terminal 43 is inserted into the inner housing 44 from the rear side of the inner housing 44. The inner housing 44 also has a function of engaging with the cylindrical portion 51 to cause the terminal portion 4 to be disposed inside the cylindrical portion 51 of the outer housing 5. Engagement of the inner housing 44 with the cylindrical portion 51 enables leaving of the terminal portion 4 from the cylindrical portion 51 to be suppressed or prevented.

### 4. Configuration of Outer Housing

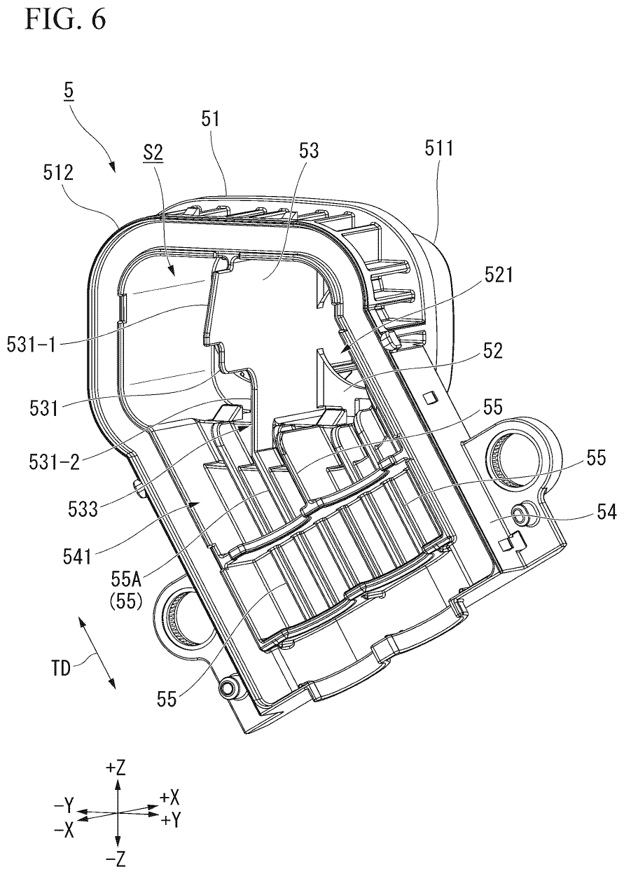

As illustrated in FIGS. 6 to 8, the outer housing 5 is made of a material having an electrical insulation property (e.g., a synthetic resin material). The outer housing 5 includes the cylindrical portion 51, a partition wall 52, an insulating wall 53, and the guide portion 54.

### 5. Configuration of Cylindrical Portion

The cylindrical portion 51 is formed in a cylindrical shape extending in the X direction. The cylindrical portion 51 has a first end 511 positioned on the front side (+X direction side) and a second end 512 positioned on the rear side (−X direction side). A portion on the first end 511 side of the cylindrical portion 51 is a fitting portion to be fitted to the mating connector 9 (see FIG. 2). As described above, the plurality of terminal portions 4 are arranged in the Y direction inside the cylindrical portion 51. Due to this configuration, the cylindrical portion 51 is formed to have a shape whose dimension in the Y direction is longer than the dimension in the Z direction as viewed in the axial direction (X direction) thereof.

### 6. Configuration of Partition Wall

The partition wall 52 is positioned inside the cylindrical portion 51 and is formed integrally with the cylindrical portion 51. The partition wall 52 partitions the space inside the cylindrical portion 51 into a first partitioned space S1 on the first end 511 side of the cylindrical portion 51 and a second partitioned space S2 on the second end 512 side of the cylindrical portion 51.

The partition wall 52 has a plurality of communication ports 521, which allow the first partitioned space S1 and the second partitioned space S2 to communicate with each other. The plurality of communication ports 521 are arranged spaced apart from each other in the Y direction. The plurality of communication ports 521 allows the respective terminal portions 4 to pass therethrough in the X direction (see FIGS. 1 to 3). Since, in the present embodiment, the number of the terminal portions 4 is two, the number of the communication ports 521 is also two. In the present embodiment, the communication ports 521 each have a circular shape in a plan view as viewed from the X direction, but the communication ports 521 may have any shape in the plan view.

### 7. Configuration of Insulating Wall

As illustrated in FIGS. 6 to 8, the insulating wall 53 is positioned between the terminal portions 4 (communication ports 521) adjacent to each other in the Y direction. The insulating wall 53 is formed to have a shape extending in the X direction and the Y direction, where the Y direction is a thickness direction of the insulating wall 53. It is sufficient for the insulating wall 53 to extend at least rearward beyond the partition wall 52. In the present embodiment, the insulating wall 53 also extends forward beyond the partition wall 52.

The insulating wall 53 has a rear end 531 (end) on the rear side (−X direction side) thereof, and the rear end 531 has a first rear end region 531-1 (first end region) and a second rear end region 531-2 (second end region). The first rear end region 531-1 is positioned in a portion of the insulating wall 53 on the +Z direction side (on one side in the second cross direction). The second rear end region 531-2 is positioned in a portion of the insulating wall 53 on the −Z direction side (on another side in the second cross direction), and is adjacent to the first rear end region 531-1 on the −Z direction side (on the another side in the second cross direction). The second rear end region 531-2 is positioned on the +X direction side (nearer to the first end 511 of the cylindrical portion 51) with respect to the first rear end region 531-1.

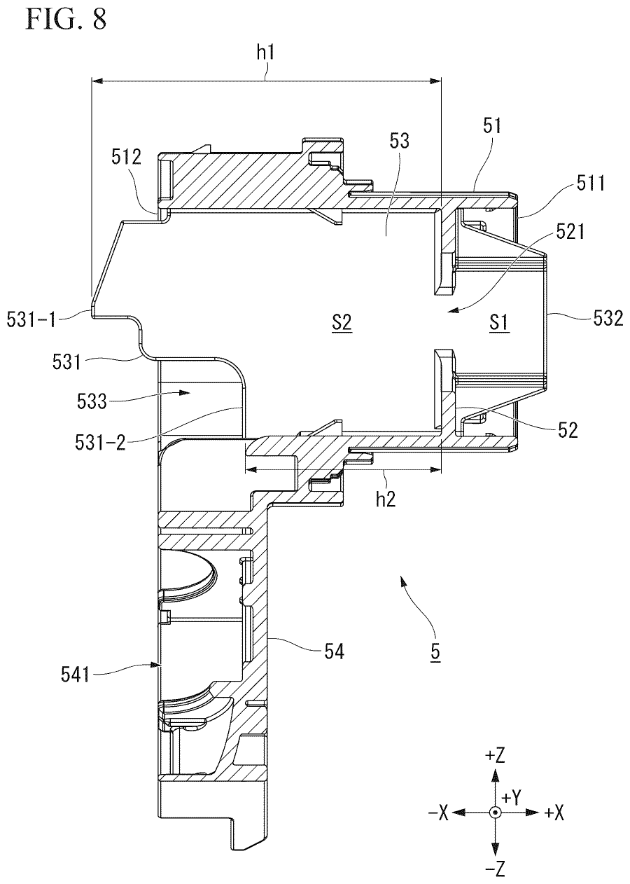

The positions of the first and second rear end regions 531-1 and 531-2 in the X direction will be described in more detail. Assuming the −X direction (direction from the first end 511 to the second end 512 of the cylindrical portion 51) as the height direction of the insulating wall 53, the second rear end region 531-2 of the insulating wall 53 is positioned at a position lower than the first rear end region 531-1. In other words, the second rear end region 531-2 has a height dimension h2 with respect to the position of the partition wall 52 that is less than a height dimension h1 of the first rear end region 531-1 (see, particularly, FIG. 8). By determining the positions of the first and second rear end regions 531-1 and 531-2 in the X direction in this manner, a recessed portion 533 recessed in the +X direction from the rear end 531 of the insulating wall 53 is formed in a portion on the −Z direction side (the another side in the second cross direction), of the rear end portion of the insulating wall 53 positioned on the −X direction side (the second end 512 side of the cylindrical portion 51). At least part of the recessed portion 533 is positioned inside the cylindrical portion 51. In FIG. 8, part of the recessed portion 533 is positioned inside the cylindrical portion 51, and the remaining part of the recessed portion 533 is positioned outside the cylindrical portion 51 (outside the second end 512 of the cylindrical portion 51). The recessed portion 533 may be positioned entirely inside the cylindrical portion 51.

As illustrated in FIG. 8, the second rear end region 531-2 of the insulating wall 53 does not protrude in the −X direction from the second end 512 of the cylindrical portion 51 and is positioned inside the cylindrical portion 51. In contrast, the first rear end region 531-1 of the insulating wall 53 is positioned so as to protrude in the −X direction (outward from the cylindrical portion 51) from the second end 512 of the cylindrical portion 51. A portion of the insulating wall 53 protruding from the second end 512 of the cylindrical portion 51 including the first rear end region 531-1 functions as a guide when the rear cover 6 (see FIG. 1) is attached to the outer housing 5. The first rear end region 531-1 may be disposed, for example, at the same position in the X direction as the second end 512 of the cylindrical portion 51, or may be positioned inside the cylindrical portion 51 similarly to the second rear end region 531-2.

FIG. 8 illustrates the portion of the insulating wall 53 positioned behind the rear side of the partition wall 52 such that both ends in the Z direction of the insulating wall 53 reach the inner surface of the cylindrical portion 51. Note that the portion of the insulating wall 53 positioned behind the rear side of the partition wall 52 may be such that, for example, one or both ends in the Z direction of the insulating wall 53 do not reach the inner surface of the cylindrical portion 51.

In FIG. 8, a front end 532 of the insulating wall 53 positioned on the front side (+X direction side) thereof is positioned to protrude from the first end 511 of the cylindrical portion 51 in the +X direction (outward from the cylindrical portion 51). The front end 532 of the insulating wall 53 may be disposed, for example, at the same position in the X direction as the first end 511 of the cylindrical portion 51 or may be positioned inside the cylindrical portion 51 without protruding from the first end 511 of the cylindrical portion 51.

FIG. 8 illustrates the portion of the insulating wall 53 positioned on the front side of the partition wall 52 such that neither end in the Z direction of the insulating wall 53 reaches the inner surface of the cylindrical portion 51. Specifically, both ends in the Z direction of the insulating wall 53 become more distant from the inner surface of the cylindrical portion 51 at a position more distant in the +X direction from the partition wall 52. Note that the portion of the insulating wall 53 positioned on the front side of the partition wall 52 may be such that, for example, one or both ends in the Z direction of the insulating wall 53 reach the inner surface of the cylindrical portion 51.

### 8. Configuration of Guide Portion

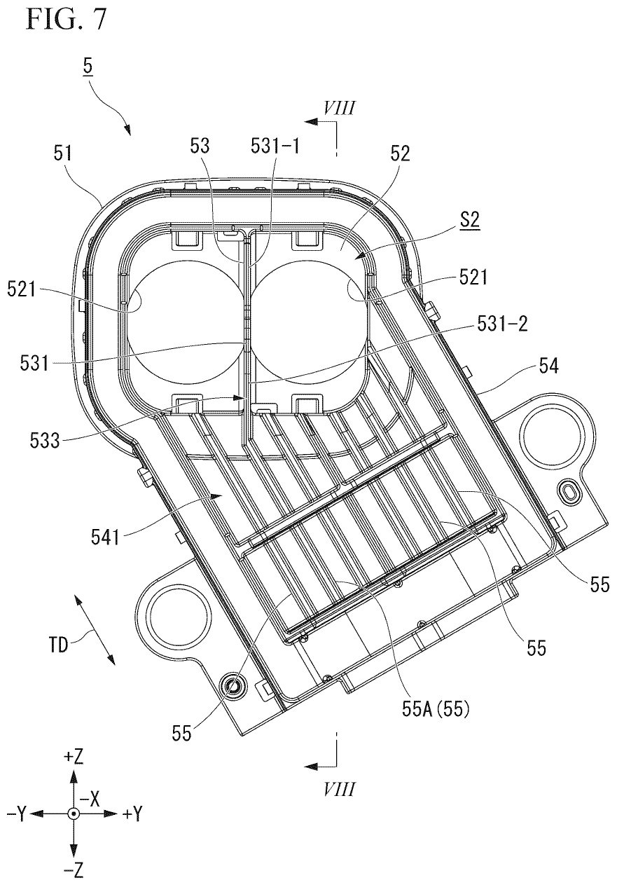

As illustrated in FIGS. 6 and 7, the guide portion 54 is connected to the cylindrical portion 51. In the present embodiment, the guide portion 54 is formed integrally with the cylindrical portion 51. For example, the guide portion 54 may be formed separately from the cylindrical portion 51 and then fixed to the cylindrical portion 51. As viewed from the X direction, the guide portion 54 extends in an oblique direction TD, which is inclined in the +Y direction (the first cross direction) as the guide portion 54 extends in the −Z direction (toward one side of the second cross direction) apart from the cylindrical portion 51. As illustrated in FIGS. 2 and 3, the guide portion 54 guides the plurality of electric wires 2 respectively extending from the base end portions 42 of the plurality of terminal portions 4, in the direction in which the guide portion 54 extends (that is, the oblique direction TD).

As illustrated in FIGS. 6 and 7, the guide portion 54 includes an electric wire housing portion 541, which houses the plurality of electric wires 2 (see FIGS. 2 and 3). The electric wire housing portion 541 opens at both ends in the oblique direction TD of the guide portion 54. The electric wire housing portion 541 also opens in the −X direction (on the second end 512 side of the cylindrical portion 51). The electric wire housing portion 541 communicates with a region on the second end 512 side of the cylindrical portion 51 (in the illustrated example, the second partitioned space S2), of the space inside the cylindrical portion 51.

The foregoing configuration of the guide portion 54 causes the plurality of electric wires 2 extending from the respective base end portions 42 of the plurality of terminal portions 4 (see FIGS. 2 and 3) to be arranged as follows. As illustrated in FIGS. 2 and 3, the electric wires 2 extending from the respective base end portion 42 of the terminal portions 4 with the terminal portions 4 being attached inside the cylindrical portion 51 are housed in the electric wire housing portion 541 of the guide portion 54, and are drawn out of the outer housing 5 through the leading end in the extending direction of the guide portion 54. The electric wires 2 housed in the electric wire housing portion 541 extend in the extending direction of the guide portion 54 (oblique direction TD).

The first electric wire 2A of the plurality of electric wires 2, which is connected to the base end portion 42 of the first terminal portion 4A, is inclined in the oblique direction TD in and after the base end portion 42 of the first terminal portion 4A, thereby approaches the insulating wall 53 positioned in the +Y direction while extending in the −Z direction from the base end portion 42 of the first terminal portion 4A, that is, approaches the portion of the insulating wall 53 on the −Z direction side. In this respect, as described above, the recessed portion 533 is formed in the portion of the insulating wall 53 on the −Z direction side. Due to this configuration, the first electric wire 2A extends toward the guide portion 54 through the recessed portion 533 of the insulating wall 53. That is, the first electric wire 2A extends toward the guide portion 54 without interfering with the insulating wall 53.

### 9. Configuration of Reinforcing Rib

As illustrated in FIGS. 6 and 7, the outer housing 5 includes reinforcing ribs 55, which reinforce the guide portion 54. The reinforcing ribs 55 protrude from the inner surface of the guide portion 54 forming the electric wire housing portion 541, and extend in the extending direction (oblique direction TD) of the guide portion 54. As viewed from the X direction, the plurality of the reinforcing ribs 55 are arranged spaced apart from one another in a direction crossing (in the illustrated example, a direction orthogonal to) the oblique direction TD.

Among the plurality of reinforcing ribs 55, one reinforcing rib 55A (hereinafter referred to as a “predetermined reinforcing rib 55A”) is connected to the insulating wall 53. Specifically, the predetermined reinforcing rib 55A is connected to an end of the insulating wall 53 positioned on the −Z direction side. The predetermined reinforcing rib 55A is formed integrally with the insulating wall 53.

### 10. Configuration of Rear Cover

The rear cover 6 illustrated in FIG. 1 closes the openings (see FIG. 2) on the −X direction side of the cylindrical portion 51 and of the guide portion 54 forming the outer housing 5. The rear cover 6 covers the terminal portions 4 attached to the outer housing 5 and the electric wires 2 from the −X direction side. The rear cover 6 is made of a material having an electrical insulation property (e.g., a synthetic resin material).

### 11. Advantages

According to the present embodiment, the rear end 531 of the insulating wall 53 positioned on the −X direction side includes the first rear end region 531-1 and the second rear end region 531-2, which is adjacent to the first rear end region 531-1 on the −Z direction side and is positioned at a position on the +X direction side (nearer to the first end 511 of the cylindrical portion 51) with respect to the first rear end region 531-1. That is, the recessed portion 533 recessed in the +X direction from the rear end 531 of the insulating wall 53 is formed in a portion on the −Z direction side (another side in the second cross direction), of the rear end portion of the insulating wall 53 positioned on the −X direction side (the second end 512 side of the cylindrical portion 51).

Such configuration enables suppression or prevention of a situation in which the electric wire 2 (first electric wire 2A) connected to the base end portion 42 of the terminal portion 4 (first terminal portion 4A) adjacent to the insulating wall 53 in the −Y direction interferes with the insulating wall 53. This point will next be described. The first electric wire 2A extending from the base end portion 42 of the first terminal portion 4A is bent toward the −Z direction side at a position at or near the base end portion 42 of the corresponding terminal portion 4 and is extended toward the +Y direction side (the insulating wall 53 side) along the −Z direction. That is, the first electric wire 2A is extended along the oblique direction TD from the base end portion 42 of the corresponding terminal portion 4. Extending the first electric wire 2A as described above enables the first electric wire 2A to pass through the recessed portion 533 of the insulating wall 53 described above. Interference of the first electric wire 2A with the insulating wall 53 can therefore be suppressed or prevented.

Another method of suppressing interference of the first electric wire 2A with the insulating wall 53 can be, for example, to form the insulating wall 53 to bend in the oblique direction TD. However, in this case, the bent portion of the insulating wall 53 will affect the shape of the arrangement portion of the second terminal portion 4B adjacent to the bent side of the cylindrical portion 51. That is, this will cause a difference between the shapes of the arrangement portions of the first and second terminal portions 4A and 4B in the cylindrical portion 51. This will require the first and second terminal portions 4A and 4B to have shapes different from each other, which will increase the manufacturing cost of the connector.

In contrast, the present embodiment requires no bending of the insulating wall 53, thereby enabling the arrangement portions of the first and second terminal portions 4A and 4B in the cylindrical portion 51 to have a same shape. As a result, the first and second terminal portions 4A and 4B can have a same shape, and the manufacturing cost of the connector can thus be reduced to a lower level.

According to the present embodiment, the outer housing 5 includes the guide portion 54, which guides the plurality of electric wires 2 extending from the respective base end portions 42 of the plurality of terminal portions 4 attached to the cylindrical portion 51 to be directed in the +Y direction (that is, in the oblique direction TD) along the −Z direction. Such configuration allows the plurality of electric wires 2 connected to the respective base end portions 42 of the plurality of terminal portions 4 to be reliably extended in the oblique direction TD.

According to the present embodiment, the insulating wall 53 provided in the cylindrical portion 51 is connected to the reinforcing ribs 55, which reinforce the guide portion 54. Such configuration can improve the strength of the insulating wall 53 and of the outer housing 5 including the insulating wall 53.

According to the present embodiment, the first rear end region 531-1 of the insulating wall 53 is positioned so as to protrude outward from the outer housing 5 from the second end 512 of the cylindrical portion 51. Such configuration enables easy attachment of the rear cover 6 to the outer housing 5 using, as a guide, the portion of the insulating wall 53 including the first rear end region 531-1, protruding from the second end 512 of the cylindrical portion 51.

### 12. Modification

In the above-described embodiment, the outer housing 5 includes the cylindrical portion 51, the partition wall 52, the insulating wall 53, the guide portion 54, and the reinforcing ribs 55. However, it is sufficient for the outer housing 5 to include at least the cylindrical portion 51 and the insulating wall 53, and the outer housing 5 does not need to include, for example, the partition wall 52, the guide portion 54, or the reinforcing ribs 55.

One embodiment and a variation thereof have been described. However, the embodiment and the variation are not limited to the examples described above. For example, the embodiment and the variation may be implemented in combination.

### BRIEF DESCRIPTION OF THE REFERENCE SYMBOLS

1 Routing unit
2 Electric wire
3 Connector
4 Terminal portion
5 Outer housing (housing)
9 Mating connector
41 Leading end portion of terminal portion 4
42 Base end portion of terminal portion 4
51 Cylindrical portion
53 Insulating wall
54 Guide portion
55 Reinforcing rib
55A Predetermined reinforcing rib
511 First end of cylindrical portion 51
512 Second end of cylindrical portion 51
531 Rear end (end)
531-1 First rear end region (first end region)
531-2 Second rear end region (second end region)
533 Recessed portion
TD Oblique direction

What is claimed is:

1. A connector comprising:
a housing having a cylindrical portion, the cylindrical portion having a portion on a first end side in an axial direction of the cylindrical portion, the portion on the first end side being a fitting portion to be fitted to a mating connector; and
a plurality of terminal portions arranged in a first cross direction crossing in the axial direction of the cylindrical portion inside the cylindrical portion, each of the terminal portions comprising a leading end portion positioned on the first end side of the cylindrical portion and to be connected to the mating connector, and a base end portion positioned on a second end side of the cylindrical portion in the axial direction and to be connected to a corresponding one of electric wires, wherein
the housing comprises an insulating wall, the insulating wall extending in the axial direction of the cylindrical portion between the terminal portions adjacent to each other in the first cross direction, the first cross direction being a thickness direction of the insulating wall, and
the insulating wall has an end positioned on the second end side of the cylindrical portion, the end comprising a first end region positioned on one side in a second cross direction and a second end region positioned adjacent to the first end region on another side in the second cross direction and positioned nearer to the first end of the cylindrical portion than the first end region, the second cross direction being a direction crossing the axial direction and the first cross direction.

2. The connector according to claim 1, wherein
the housing comprises a guide portion extending in an oblique direction as viewed in the axial direction, the oblique direction being inclined in the first cross direction as the guide portion extends on one side in the second cross direction apart from the cylindrical portion toward one side, and
the guide portion guides the plurality of electric wires respectively extending from the base end portions of the plurality of terminal portions in a direction in which the guide portion extends.

3. The connector according to claim 2, wherein
the housing comprises a reinforcing rib that reinforces the guide portion, and
the insulating wall is connected to the reinforcing rib.

4. The connector according to claim 1, wherein the first end region of the insulating wall is positioned to protrude outward from the second end of the cylindrical portion.

5. A routing unit comprising: the connector according to claim 1; and a plurality of electrical wires respectively connected to the base end portions of the plurality of terminal portions.
